(19) United States
(12) Patent Application Publication
(10) Pub. No.: US 2025/0053121 A1
(43) Pub. Date: Feb. 13, 2025

(54) FIXING DEVICE AND IMAGE FORMING APPARATUS

(71) Applicant: FUJIFILM Business Innovation Corp., Tokyo (JP)

(72) Inventors: Masato YAMASHITA, Kanagawa (JP); Yoshiki SHIMODAIRA, Kanagawa (JP); Hideki KUGE, Kanagawa (JP); Takayuki UKAWA, Kanagawa (JP)

(73) Assignee: FUJIFILM Business Innovation Corp., Tokyo (JP)

(21) Appl. No.: 18/596,554

(22) Filed: Mar. 5, 2024

(30) Foreign Application Priority Data
Aug. 9, 2023 (JP) 2023-130497

(51) Int. Cl. G03G 15/20; G03G 21/20

(52) U.S. Cl. CPC G03G 15/2021; G03G 15/2064; G03G 21/206; G03G 2215/00666; G03G 2221/1645

(57) ABSTRACT

A fixing device includes: a conveyance section that conveys a recording medium; a heating roll that rotates and heats the recording medium being conveyed by the conveyance section; a pressure roll that is disposed to face the heating roll and rotates, around which at least a portion of the recording medium being conveyed is wound, and that pressurizes the wound portion of the recording medium toward the heating roll; a gripping section that is disposed in the conveyance section, grips a leading end of the recording medium being conveyed, and releases the gripping of the leading end of the recording medium when the recording medium passes through a facing position where the pressure roll and the heating roll face each other; and a blowing section that blows air in a direction different from a direction toward the recording medium released from being gripped by the gripping section to cool the pressure roll.

### CROSS-REFERENCE TO RELATED APPLICATIONS

This application is based on and claims priority under 35 USC 119 from Japanese Patent Application No. 2023-130497 filed Aug. 9, 2023.

### BACKGROUND

### (i) Technical Field

The present invention relates to a fixing device and an image forming apparatus.

### (ii) Related Art

A printing apparatus described in JP2003-39635A is provided with a drying device for drying a print sheet printed by a printing unit when the print sheet is conveyed toward a sheet discharge unit, and includes a plurality of holding means for holding sheet-like printed matter, a traveling means for circulating the holding means along an endless conveyance path to cause the holding means to travel along a first conveyance path from the printing unit to the sheet discharge unit while holding the printed matter, and to travel along a second conveyance path returning from the sheet discharge unit to the printing unit while not holding the printed matter, a drying means installed near the first conveyance path to dry the printed matter, and an air shielding means provided along the conveyance path such that warm air generated by the drying means is substantially guided only to the first conveyance path.

### SUMMARY

In a configuration in which a conveyance section that conveys a recording medium by gripping a leading end of the recording medium with a gripping section and moving the gripping section is provided, the recording medium being conveyed is heated by passing through a facing position where a rotating pressure roll and a heating roll face each other. Next, the gripping section that grips the leading end of the recording medium releases the gripping of the leading end of the recording medium after the gripping section passes through the facing position where the pressure roll and the heating roll face each other. Further, since the pressure roll is heated by the heating roll, it is necessary to cool the pressure roll.

Here, if air blown to the pressure roll in order to cool the pressure roll directly hits the recording medium released from being gripped by the gripping section, a conveyance failure may occur in the recording medium being conveyed.

Aspects of non-limiting embodiments of the present disclosure relate to a fixing device that suppresses a conveyance failure that occurs in a recording medium being conveyed, as compared with a case where air for cooling a pressure roll directly hits the recording medium released from being gripped by a gripping section.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device comprising:
a conveyance section that conveys a recording medium;
a heating roll that rotates and heats the recording medium being conveyed by the conveyance section;
a pressure roll that is disposed to face the heating roll and rotates, around which at least a portion of the recording medium being conveyed is wound, and that pressurizes the wound portion of the recording medium toward the heating roll;
a gripping section that is disposed in the conveyance section, grips a leading end of the recording medium being conveyed, and releases the gripping of the leading end of the recording medium when the recording medium passes through a facing position where the pressure roll and the heating roll face each other; and
a blowing section that blows air in a direction different from a direction toward the recording medium released from being gripped by the gripping section to cool the pressure roll.

### BRIEF DESCRIPTION OF THE DRAWINGS

Exemplary embodiments of the present invention will be described in detail based on the following figures, wherein:

FIG. 1 is a schematic diagram illustrating an image forming apparatus according to an exemplary embodiment of the present disclosure;

FIG. 2 is a schematic configuration diagram illustrating a toner image forming section of the image forming apparatus according to the exemplary embodiment of the present disclosure;

FIG. 3 is a perspective view illustrating a conveyance mechanism of the image forming apparatus according to the exemplary embodiment of the present disclosure;

FIG. 4 is a configuration diagram illustrating a cooling unit of the image forming apparatus according to the exemplary embodiment of the present disclosure;

FIG. 5 is a perspective view illustrating a conveyance mechanism of the image forming apparatus according to the exemplary embodiment of the present disclosure;

FIG. 6 is a configuration diagram illustrating a fixing device according to the exemplary embodiment of the present disclosure;

FIG. 7 is a perspective view illustrating a main heating section of the fixing device according to the exemplary embodiment of the present disclosure;

FIG. 8 is a configuration diagram illustrating a preliminary heating section of the fixing device according to the exemplary embodiment of the present disclosure;

FIG. 9 is a configuration diagram illustrating the main heating section of the fixing device according to the exemplary embodiment of the present disclosure;

FIG. 10 is an explanatory diagram of the main heating section of the fixing device according to the exemplary embodiment of the present disclosure, illustrating a state in which a pressure roll is rotating;

FIG. 11 is an explanatory diagram of the main heating section of the fixing device according to the exemplary embodiment of the present disclosure, illustrating a state in which the pressure roll is rotating;

FIG. 12 is an explanatory diagram of the main heating section of the fixing device according to the exemplary embodiment of the present disclosure, illustrating a state in which the pressure roll is rotating;

FIG. 13 is an enlarged configuration diagram of the main heating section of the fixing device according to the exemplary embodiment of the present disclosure, illustrating a suppressing member, a storage portion, and the like;

FIG. 14 is a diagram illustrating a fluid analysis result of the fixing device according to the exemplary embodiment of the present disclosure;

FIG. 15 is a diagram illustrating a fluid analysis result of the fixing device according to the exemplary embodiment of the present disclosure;

FIG. 16 is a configuration diagram illustrating a fixing device according to a comparative embodiment to the exemplary embodiment of the present disclosure; and

FIG. 17 is a diagram illustrating a fluid analysis result of the fixing device according to the comparative embodiment to the exemplary embodiment of the present disclosure.

### DETAILED DESCRIPTION

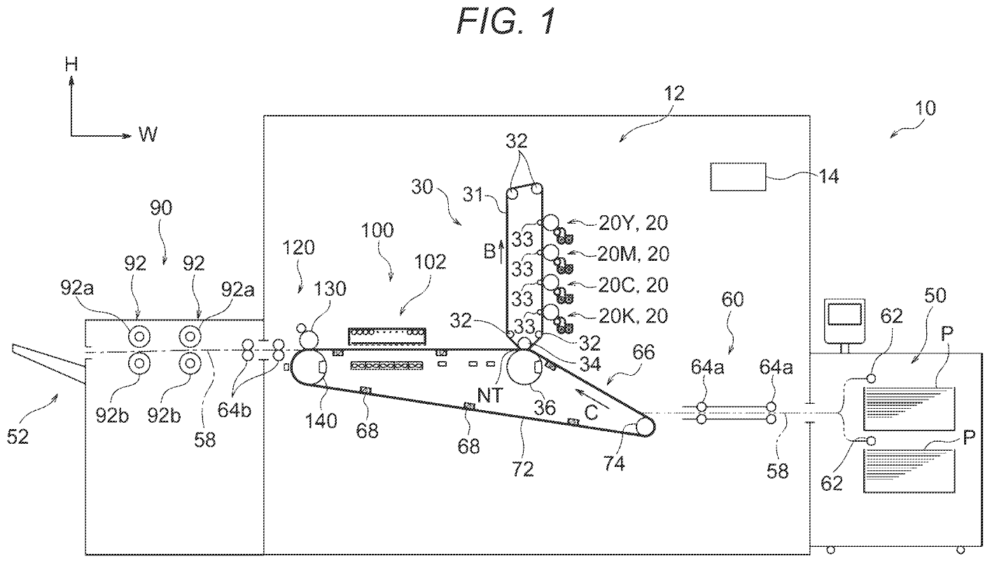

An example of a fixing device and an image forming apparatus according to an exemplary embodiment of the present disclosure will be described with reference to FIGS. 1 to 17. In each of the drawings, an arrow H indicates a top-bottom direction (vertical direction) of the apparatus, an arrow W indicates a width direction (horizontal direction) of the apparatus, and an arrow D indicates a depth direction (horizontal direction) of the apparatus.

### (Image Forming Apparatus 10)

The image forming apparatus 10 according to the present exemplary embodiment is an electrophotographic image forming apparatus that forms a toner image on a sheet member P as a recording medium. As illustrated in FIG. 1, the image forming apparatus 10 includes medium storage portions 50, a discharge unit 52, an image forming section 12, a conveyance mechanism 60, a fixing device 100, a cooling unit 90, and a control unit 14 that controls each component of the image forming apparatus 10.

### [Medium Storage Portions 50]

As illustrated in FIG. 1, the two medium storage portions 50 are disposed in a portion on one side (the right side in the drawing) in the width direction and are arranged side by side in the vertical direction in the image forming apparatus 10. Each of the medium storage portions 50 stores a sheet member P, and a sheet member P is selectively sent out from the two medium storage portions 50.

### [Discharge Unit 52]

As illustrated in FIG. 1, the discharge unit 52 is disposed in a portion on the other side (the left side in the drawing) in the width direction in the image forming apparatus 10, and a sheet member P on which a toner image is formed is discharged to the discharge unit 52. Specifically, after the toner image is fixed onto the sheet member P by the fixing device 100, the sheet member P cooled by the cooling unit 90 is discharged to the discharge unit 52.

### [Image Forming Section 12]

As illustrated in FIG. 1, the image forming section 12 includes toner image forming sections 20 that are disposed between the medium storage portions 50 and the discharge unit 52 in the width direction and form toner images, and a transfer device 30 that transfers the toner images formed by the toner image forming sections 20 onto the sheet member P.

Furthermore, the plurality of toner image forming sections 20 are provided so as to form toner images in respective colors. The image forming apparatus 10 includes the toner image forming sections 20 for a total of four colors of yellow (Y), magenta (M), cyan (C), and black (K). (Y), (M), (C), and (K) illustrated in FIG. 1 indicate components corresponding to the respective colors described above. In the following description, Y, M, C, and K may be omitted when Y, M, C, and K are not particularly distinguished from each other.

### —Toner Image Forming Sections 20—

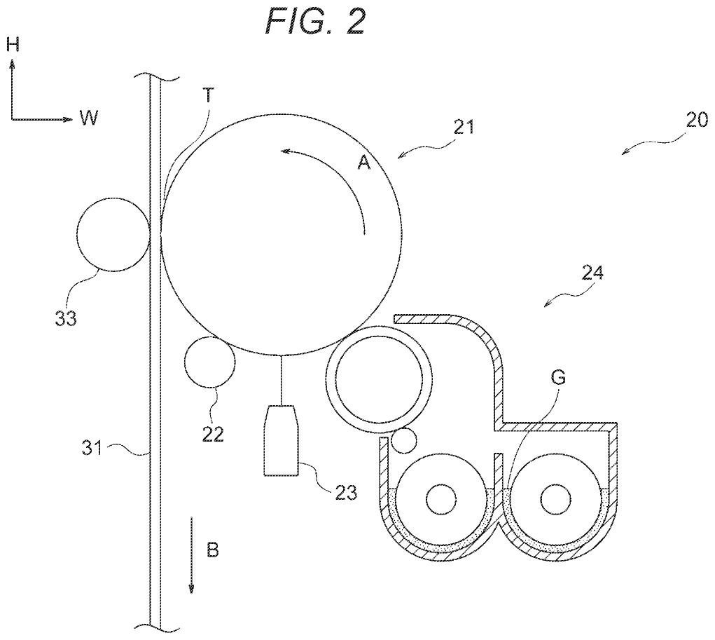

The toner image forming sections 20 for the respective colors are basically configured in the same manner, except for toners to be used. Specifically, as illustrated in FIG. 2, each of the toner image forming sections 20 for the respective colors includes a photosensitive drum 21 that rotates in the direction of arrow A in FIG. 2, and a charger 22 that charges the photosensitive drum 21. Further, each of the toner image forming sections 20 for the respective colors includes an exposure device 23 that forms an electrostatic latent image on the photosensitive drum 21 by exposing the photosensitive drum 21 charged by the charger 22, and a developing device 24 that develops the electrostatic latent image formed on the photosensitive drum 21 by the exposure device 23 using toner.

### —Transfer Device 30—

As illustrated in FIG. 1, the transfer device 30 includes a transfer belt 31 serving as an intermediate transfer member, primary transfer rolls 33, a secondary transfer roll 34, and a counter roll 36. The transfer device 30 is an example of a transfer section.

The primary transfer rolls 33 transfer the toner images formed on the photosensitive drums 21 onto the transfer belt 31 at primary transfer positions T (see FIG. 2) between the photosensitive drums 21 and the primary transfer rolls 33.

The transfer belt 31 has an endless shape and is wound around a plurality of rolls 32 such that the posture of the transfer belt 31 is determined. When at least one of the plurality of rolls 32 is driven to rotate, the transfer belt 31 rotates in the direction of arrow B and conveys the primarily transferred images to a secondary transfer position NT.

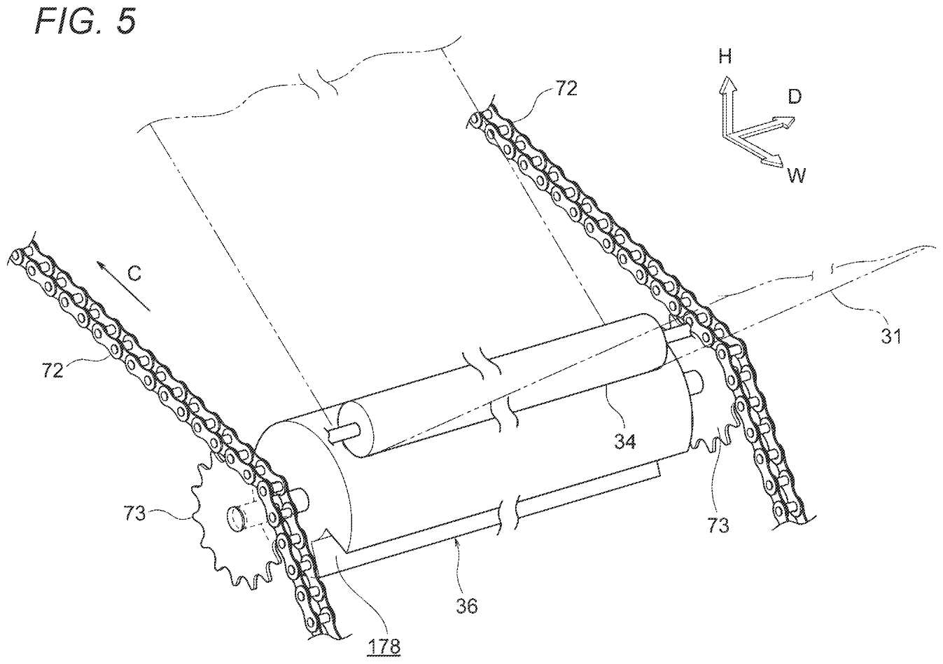

A portion of the transfer belt 31 is wound around the secondary transfer roll 34, and the counter roll 36 is disposed to face the secondary transfer roll 34 with the transfer belt 31 interposed between the counter roll 36 and the secondary transfer roll 34 (see FIG. 5).

Thus, the secondary transfer roll 34 rotates along with the circulating transfer belt 31, and transfers the toner images on the transfer belt 31 onto a sheet member P that is conveyed while being sandwiched between the rotating counter roll 36 and the transfer belt 31 and passes through the secondary transfer position NT.

### [Conveyance Mechanism 60]

As illustrated in FIG. 1, the conveyance mechanism 60 includes a feed roll 62 that feeds a sheet member P stored in each of the medium storage portions 50 to a conveyance path 58 for the sheet member P, a plurality of conveyance rolls 64a and 64b that convey the sheet member P fed to the conveyance path 58, and a chain gripper 66.

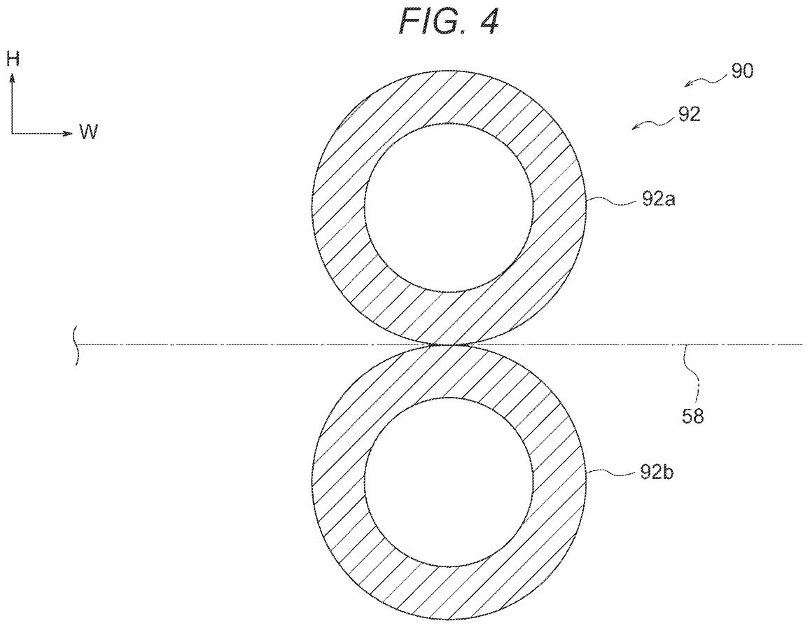

The plurality of conveyance rolls 64a convey the sheet member P fed from the feed roll 62 to the chain gripper 66, and the plurality of conveyance rolls 64b convey the sheet member P conveyed by the chain gripper 66 to the cooling unit 90 (see FIG. 4).

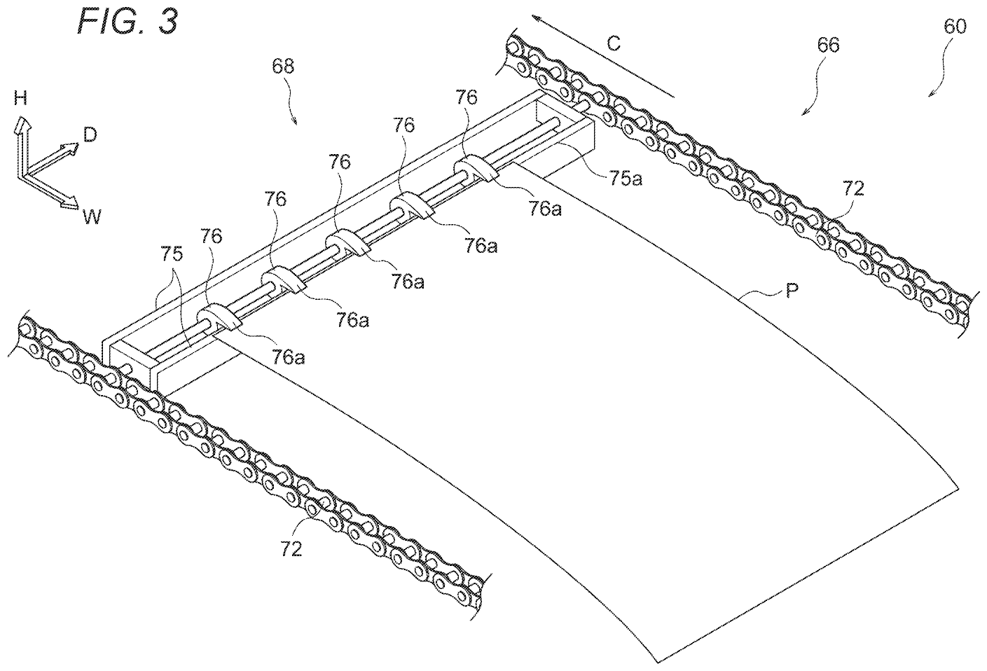

As illustrated in FIG. 3, the chain gripper 66 includes a pair of chains 72 and holding sections 68 that hold a leading end of the sheet member P. Note that the chain gripper 66 is also a constituent member of the fixing device 100, and therefore, will be described together with the fixing device 100 described later.

### [Fixing Device 100]

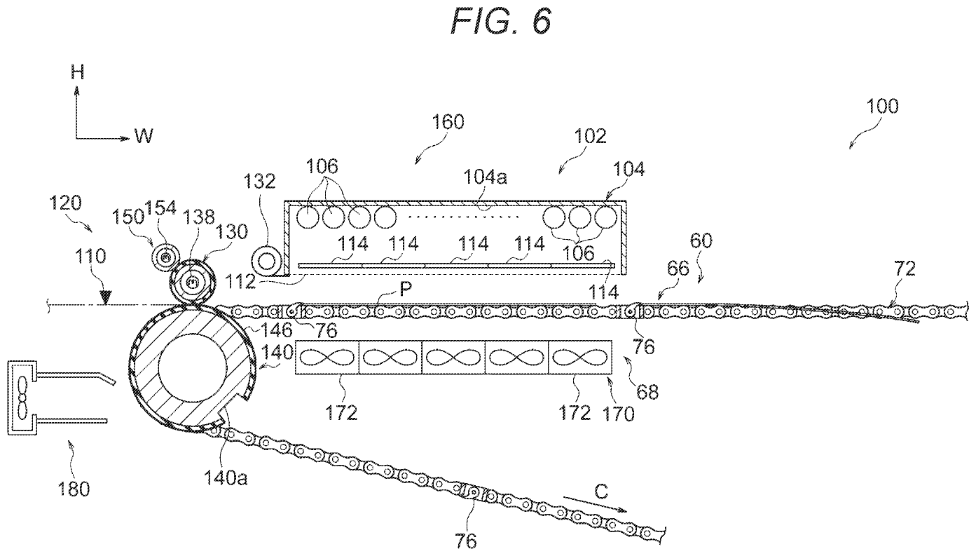

As illustrated in FIG. 6, the fixing device 100 includes the chain gripper 66 and a preliminary heating section 102 that is disposed downstream of the transfer device 30 (see FIG. 1) in the conveyance direction of the sheet member P, and heats the sheet member Pin a state where the preliminary heating section 102 is not in contact with the sheet member P.

Furthermore, the fixing device 100 includes a main heating section 120 that contacts, heats, and pressurizes the sheet member P, a blowing unit 170, and a fan 180. A heating section 160 that includes the preliminary heating section 102 and the main heating section 120 and heats the sheet member P is formed.

### [Chain Gripper 66]

As illustrated in FIG. 3, the chain gripper 66 includes the pair of chains 72 and the holding sections 68 that hold the sheet member P. The chain gripper 66 is an example of a conveyance section.

### —Chains 72—

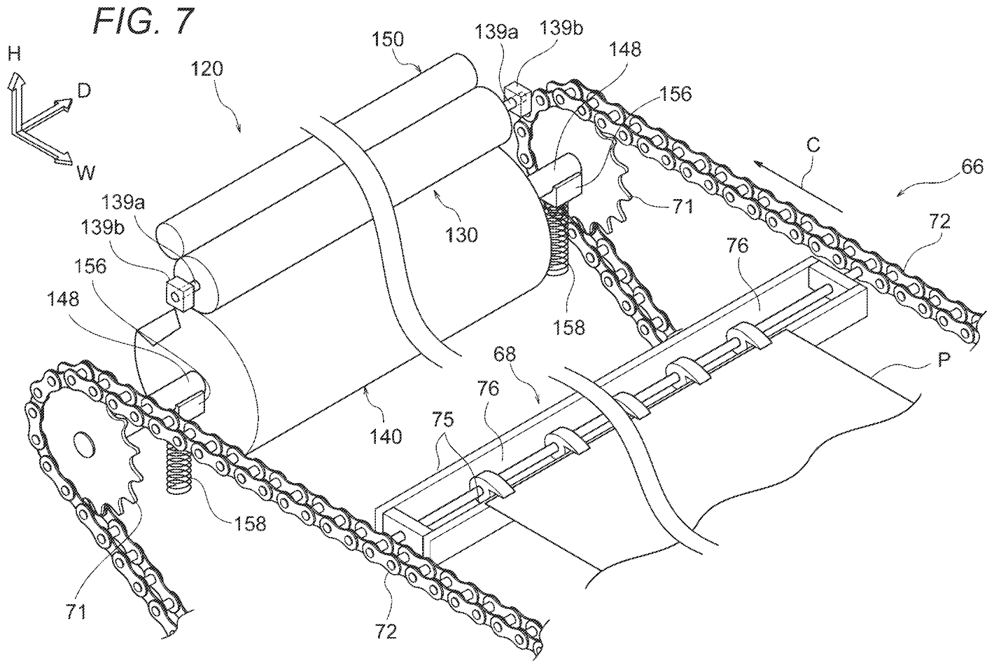

As illustrated in FIG. 3, the pair of chains 72 is disposed apart from each other in the depth direction of the apparatus. As illustrated in FIG. 5, the pair of chains 72 is wound around a pair of sprockets 73 disposed on one end side and the other end side of the counter roll 36 in the axial direction of the counter roll 36 and having axes extending in the depth direction of the apparatus, a pair of sprockets 71 (see FIG. 7) disposed on one end side and the other end side of a pressure roll 140 in the axial direction of the pressure roll 140 (described later), and a pair of sprockets 74 (see FIG. 1) disposed at an interval in the depth direction of the apparatus. As any one of each of these pairs of sprockets rotates, the chains 72 circulate in the direction of arrow C.

Both end portions of each of the holding sections 68 that hold the sheet member P are attached to the pair of chains 72. The chains 72 are an example of a moving section.

### —Holding Sections 68—

As illustrated in FIG. 3, each of the holding sections 68 includes an attachment member 75 whose both end portions are attached to the pair of chains 72, and which extends in the depth direction of the apparatus, and grippers 76 attached to the attachment member 75. The plurality of holding sections 68 are provided and are arranged at predetermined intervals along a circumferential direction (circulation direction) of the chains 72. The grippers 76 are an example of a gripping section.

The plurality of grippers 76 are provided and are attached to the attachment member 75 at predetermined intervals along the depth direction of the apparatus. Specifically, each of the grippers 76 has a claw 76a. In addition, a contact portion 75a with which the claws 76a come into contact is formed in the attachment member 75. Accordingly, the grippers 76 grip the leading end of the sheet member P by sandwiching the leading end of the sheet member P between the claws 76a and the contact portion 75a. For example, the claws 76a of the grippers 76 are pressed against the contact portion 75a by a spring or the like, and the claws 76a are brought into contact with and separated from the contact portion 75a by the action of a cam or the like.

In this configuration, when the chains 72 rotate in the direction of arrow C, the chain gripper 66 illustrated in FIG. 1 receives the sheet member P conveyed by the conveyance rolls 64a and conveys the sheet member P to the second transfer position NT while gripping the leading end of the sheet member P. Further, the chain gripper 66 causes the sheet member P to pass through the preliminary heating section 102 and then conveys the sheet member P to the main heating section 120.

### [Main Heating Section 120]

As illustrated in FIG. 6, the main heating section 120 is disposed downstream of the preliminary heating section 102 in the conveyance direction of the sheet member P. The main heating section 120 includes a heating roll 130 that comes into contact with the sheet member P being conveyed to heat the sheet member P, the pressure roll 140 that pressurizes the sheet member P toward the heating roll 130, and a driven roll 150 that rotates following the rotation of the rotating heating roll 130.

### —Heating Roll 130—

As illustrated in FIG. 6, the heating roll 130 comes into contact with an upward facing surface of the sheet member P being conveyed, and extends in the depth direction of the apparatus such that the axis direction of the heating roll 130 is the depth direction of the apparatus. Furthermore, the heating roll 130 includes a heater 138 therein.

Furthermore, as illustrated in FIG. 7, shaft portions 139a extending in the depth direction of the apparatus are formed at both end portions of the heating roll 130 in the depth direction of the apparatus. Support members 139b are provided to support the shaft portions 139a. Thus, the heating roll 130 is rotatably supported by the support members 139b at both end portions of the heating roll 130.

### —Driven Roll 150—

As illustrated in FIGS. 6 and 7, the driven roll 150 is disposed on an opposite side of the sheet member P conveyed with the heating roll 130 interposed between the driven roll 150 and the sheet member P, and extends in the depth direction of the apparatus such that the axial direction of the driven roll 150 is the depth direction of the apparatus. Furthermore, the driven roll 150 includes a heater 154 therein.

In this configuration, the driven roll 150 rotates following the rotation of the heating roll 130. Then, the driven roll 150 heats the heating roll 130.

### —Pressure Roll 140—

As illustrated in FIG. 7, the pressure roll 140 is disposed on an opposite side of the heating roll 130 with the sheet member P being conveyed and interposed between the pressure roll 140 and the heating roll 130, comes in contact with a downward facing surface of the sheet member P being conveyed, and extends in the depth direction of the apparatus such that the axial direction of the pressure roll 140 is the depth direction of the apparatus. The pressure roll 140 has a pair of shaft portions 148 formed at both end portions of the pressure roll 140 in the depth direction of the apparatus. The outer diameter of the pressure roll 140 is made larger than the outer diameter of the heating roll 130.

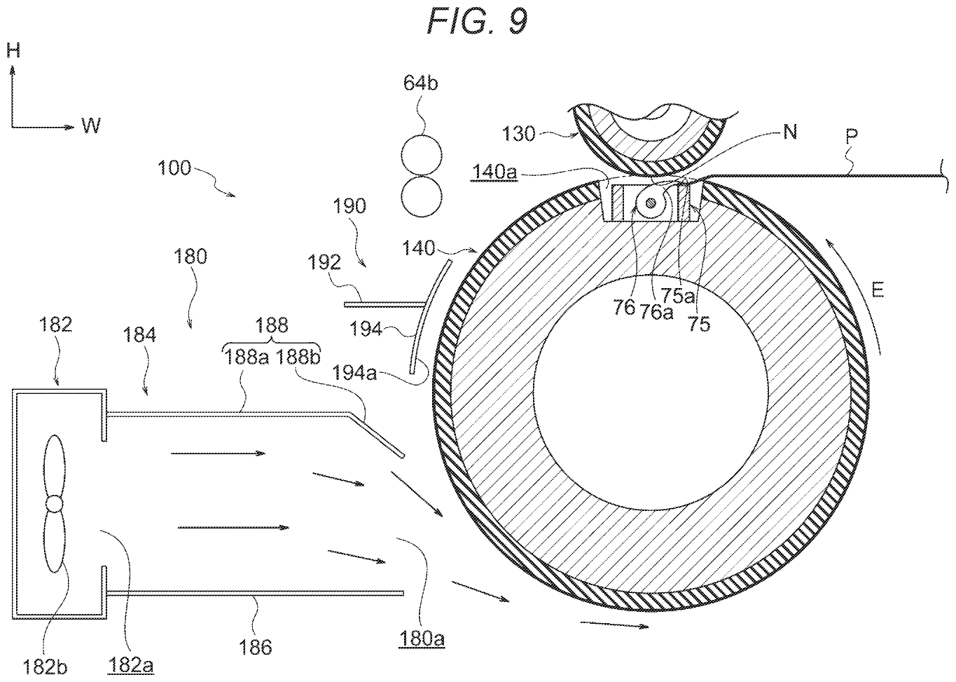

Furthermore, as illustrated in FIG. 9, a recessed storage portion 140a that extends in the depth direction of the apparatus is formed in an outer peripheral surface of the pressure roll 140. When the sheet member P passes between the pressure roll 140 and the heating roll 130, the grippers 76 that grip the leading end of the sheet member P are stored in the storage portion 140a.

### —Fan 180—

As illustrated in FIG. 6, the fan 180 is disposed to face the pressure roll 140 in the width direction of the apparatus, and cools the pressure roll 140. Note that the fan 180 will be described in detail later.

### —Others—

As illustrated in FIG. 7, the main heating section 120 includes support members 156 that support the pressure roll 140 and biasing members 158 that bias the pressure roll 140 toward the heating roll 130 side via the support members 156. The pair of support members 156 is provided. The pair of support members 156 is disposed so as to rotatably support the pair of shaft portions 148 of the pressure roll 140 from below.

In addition, as illustrated in FIG. 6, a sensor 110 that is an optical sensor that detects the sheet member P being conveyed is disposed downstream of a facing position where the heating roll 130 and the pressure roll 140 face each other in the conveyance direction of the sheet member P.

In this configuration, the pair of biasing members 158 biases the pressure roll 140 toward the heating roll 130, and thus the pressure roll 140 pressurizes, toward the heating roll 130, a portion of the sheet member P of which at least the portion is wound around the pressure roll 140. Furthermore, the pressure roll 140 is rotated by a rotational force transmitted from a driving member (not illustrated). Next, the heating roll 130 rotates following the rotation of the pressure roll 140, and the driven roll 150 rotates following the rotation of the heating roll 130. Furthermore, the heating roll 130 and the pressure roll 140 sandwich and convey the sheet member P to which the toner images have been transferred, whereby the toner images are fixed to the sheet member P. In this way, the heating roll 130 and the pressure roll 140 sandwich and convey the sheet member P while rotating, and heat the sheet member P, whereby the toner images are fixed to the sheet member P.

### [Preliminary Heating Section 102]

As illustrated in FIG. 6, the preliminary heating section 102 is disposed downstream of the second transfer position NT (refer to FIG. 1) where the toner images are transferred onto the sheet member P, and upstream of the main heating section 120 in the conveyance direction of the sheet member P. Furthermore, the preliminary heating section 102 is disposed above the sheet member P being conveyed. In other words, the preliminary heating section 102 is disposed on the side on which the toner images are transferred onto the sheet member P being conveyed.

The preliminary heating section 102 includes a reflecting member 104, a plurality of infrared heaters 106 (hereinafter, referred to as “heaters 106”), heating plates 114, a metal mesh 112, and a shutter 132.

### —Reflecting Member 104—

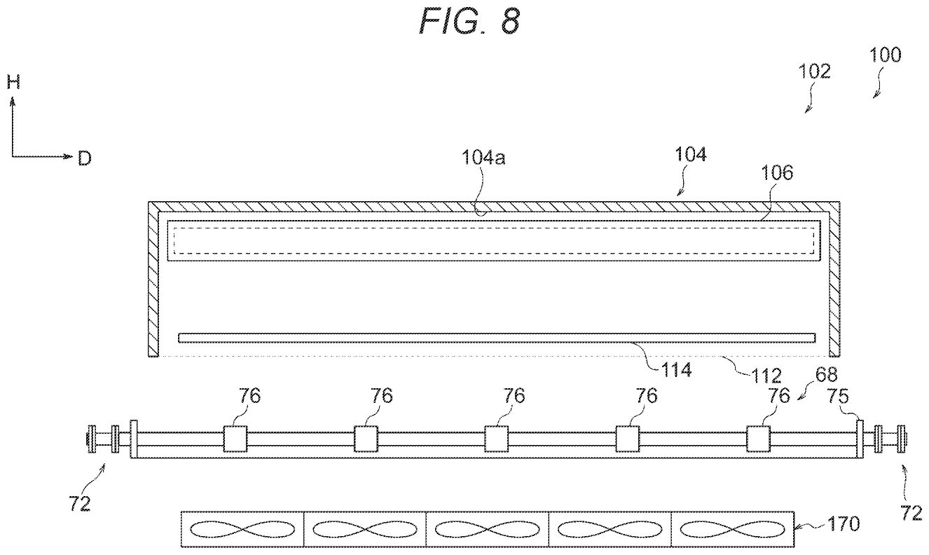

The reflecting member 104 is formed using an aluminum plate. As illustrated in FIG. 6, the reflecting member 104 is formed in a box shape with a shallow bottom that is open on the side where the sheet member P is conveyed. As illustrated in FIG. 8, in the reflecting member 104, the heating plates 114 and the heaters 106 are disposed in this order from the side where the sheet member P is conveyed. In addition, a reflecting surface 104a that reflects infrared rays, which are heat rays emitted by the heaters 106, toward the heating plates 114 is formed on the reflecting member 104.

### —Heaters 106—

The heaters 106 are infrared heaters having a cylindrical outer shape. As illustrated in FIG. 8, the heaters 106 face the reflecting surface 104a of the reflecting member 104 in the vertical direction of the apparatus, and extend in the depth direction of the apparatus. Furthermore, the plurality of heaters 106 are provided, and are arranged in the width direction of the apparatus as illustrated in FIG. 6.

### —Heating Plates 114—

As illustrated in FIG. 6, the heating plates 114 are disposed between the chains 72 and the heaters 106, and are arranged in the width direction of the apparatus.

In this configuration, the heating plates 114 absorb the infrared rays emitted by the heaters 106 and the infrared rays reflected by the reflecting surface 104a to increase in temperature and radiate heat. Then, the heating plates 114 whose temperatures have risen heat the sheet member P being conveyed in a non-contact manner.

### —Metal Mesh 112—

The metal mesh 112 is fixed to an edge portion of the reflecting member 104 with a fixing member (not illustrated), and partitions between the inside of the reflecting member 104 and the outside of the reflecting member 104 as illustrated in FIG. 6. Thus, the metal mesh 112 prevents the sheet member P being conveyed from contacting the heating plates 114.

### —Shutter 132—

As illustrated in FIG. 6, the shutter 132 is disposed adjacent to the reflecting member 104 in a rolled-up state, and covers the opening of the reflecting member 104 in a rolled-out state.

In this configuration, when the preliminary heating section 102 is operated, the shutter 132 opens the opening of the reflecting member 104, and when the preliminary heating section 102 is not operated, the shutter 132 covers the opening of the reflecting member 104.

### [Blowing Unit 170]

As illustrated in FIG. 6, the blowing unit 170 is disposed to face the preliminary heating section 102 in the vertical direction of the apparatus, and the sheet member P is conveyed and passes between the blowing unit 170 and the preliminary heating section 102. Furthermore, the blowing unit 170 includes a plurality of fans 172 arranged in the width direction of the apparatus and the depth direction of the apparatus.

In this configuration, the plurality of fans 172 blow air toward the sheet member P being conveyed, thereby stabilizing the traveling posture of the sheet member P being conveyed.

### [Cooling Unit 90]

As illustrated in FIG. 1, the cooling unit 90 is disposed downstream of the fixing device 100 in the conveyance direction of the sheet member P. The cooling unit 90 includes two cooling rolls 92 aligned in the width direction of the apparatus. The two cooling rolls 92 have the same configuration, and therefore, one of the cooling rolls 92 will be described.

As illustrated in FIG. 4, the cooling roll 92 includes a cylindrical cooling roll 92a disposed on the upper side of the conveyance path 58 for the sheet member P, and a cylindrical cooling roll 92b disposed on the lower side of the conveyance path 58 for the sheet member P.

In this configuration, a flow of air is generated by a blowing mechanism (not illustrated) such that the air flows through the inside of the cylindrical cooling roll 92, and thus the temperature of the surface of the cooling roll 92 decreases. Further, the cooling roll 92b is rotated by a rotating force transmitted from a driving member (not illustrated). Furthermore, the cooling roll 92a rotates following the rotation of the cooling roll 92b. The cooling rolls 92a and 92b sandwich and convey the sheet member P, and cool the sheet member P.

### (Operation of Entire Configuration)

Next, operations of the image forming apparatus 10 will be described.

In the image forming apparatus 10 illustrated in FIG. 1, an image is formed as follows.

First, the chargers 22 for the respective colors (illustrated in FIG. 2) to which a voltage is applied negatively charge the surfaces of the photosensitive drums 21 for the respective colors uniformly at a predetermined potential. Subsequently, the exposure devices 23 irradiate the charged surfaces of the photosensitive drums 21 for the respective colors with exposure light based on image data input from the outside to form electrostatic latent images.

Thus, the electrostatic latent images corresponding to the image data are formed on the surfaces of the photosensitive drums 21. Furthermore, the developing devices 24 for the respective colors develop the electrostatic latent images and visualize the electrostatic latent images as toner images. The primary transfer rolls 33 of the transfer device 30 transfer the toner images formed on the surfaces of the photosensitive drums 21 for the respective colors onto the transfer belt 31.

Therefore, the sheet member P, which has been sent out from the medium storage portion 50 illustrated in FIG. 1 to the conveyance path 58 by the feed roll 62 and passed from the conveyance rolls 64a to the chain gripper 66, is sent out to the second transfer position NT at which the transfer belt 31 and the counter roll 36 are in contact with each other. Specifically, the grippers 76 grip the leading end of the sheet member P, and the sheet member P is passed from the conveyance rolls 64a to the chain gripper 66.

In addition, at the second transfer position NT, the sheet member P is conveyed while being sandwiched between the transfer belt 31 and the counter roll 36, and thus the toner images on the surface of the transfer belt 31 are transferred onto the surface of the sheet member P.

Further, the chain gripper 66 conveys the sheet member P to which the toner images have been transferred. In addition, the fans 172 illustrated in FIG. 6 are operated, and the fans 172 blow air to the sheet member P from below such that the sheet surface of the sheet member P is directed in the vertical direction.

Furthermore, a voltage is applied to the heaters 106 of the preliminary heating section 102. The heating plates 114 absorb the infrared rays emitted by the heaters 106 to which the voltage has been applied and the infrared rays reflected by the reflecting surface 104a, increase in temperature, and radiate heat. Then, the heating plates 114 that have increased in temperature heat the sheet member P conveyed by the chain gripper 66 from above in a non-contact manner. The heating of the sheet member P softens the toner constituting the toner images transferred onto the sheet member P.

Furthermore, in the main heating section 120, the heating roll 130 and the pressure roll 140 sandwich and convey the sheet member P heated by the heating plates 114 of the preliminary heating section 102, and fix the toner images onto the sheet member P. The sheet member P to which the toner images have been fixed is released from being gripped by the grippers 76, is conveyed by the conveyance rolls 64b illustrated in FIG. 1, passes through the cooling unit 90, and is discharged to the discharge unit 52.

### (Configuration of Main Part)

Next, the fan 180, the preventing member 190 that prevents air blown from the fan 180 to the pressure roll 140 from flowing to the side where the sheet member P is conveyed, and the like will be described. The fan 180 is an example of a blowing section.

### [Fan 180]

As illustrated in FIG. 9, the fan 180 is disposed on the other side (the left side in the drawing) with respect to the pressure roll 140 in the width direction of the apparatus so as to face a lower portion of the pressure roll 140 in the width direction of the apparatus. The fan 180 extends in the depth direction of the apparatus and is disposed so as to blow air to the lower portion of the pressure roll 140 over the entire region of the pressure roll 140 in the depth direction of the apparatus. The fan 180 includes a fan main body 182 that blows out air and a guide portion 184 that guides the air blown out by the fan main body 182. The fan body 182 and the guide portion 184 are arranged in this order from the other side to the one side in the width direction of the apparatus.

The fan body 182 includes a plurality of propellers 182b arranged in the depth direction of the apparatus, and an opening 182a of the fan body 182 faces the pressure roll 140 side.

Furthermore, the guide portion 184 has a tubular shape that opens in the width direction of the apparatus, and a base end portion of the guide portion 184 is attached to the fan main body 182 so as to surround the opening 182a of the fan main body 182.

A cross section of the guide portion 184 has a rectangular tube shape, and the guide portion 184 includes a bottom plate 186, a top plate 188, and a pair of side plates (not illustrated). The bottom plate 186 has a thickness in the vertical direction, and has a rectangular shape as viewed from above.

The outer shape of the top plate 188 overlaps the outer shape of the bottom plate 186 as viewed from above, and the top plate 188 includes a horizontal portion 188a that extends in the width direction of the apparatus as viewed from the depth direction of the apparatus, and an inclined portion 188b that is inclined with respect to the width direction of the apparatus. The horizontal portion 188a and the inclined portion 188b are arranged side by side in this order from the other side to the one side in the width direction of the apparatus.

The inclined portion 188b is inclined with respect to the horizontal direction such that a portion of the inclined portion 188b on the pressure roll 140 side is positioned lower than a portion of the inclined portion 188b on the fan body 182 side. A blowing port 180a of the fan 180 faces the lower portion of the pressure roll 140 in the width direction of the apparatus. Here, the lower portion of the pressure roll 140 is a lower portion with respect to the center of the rotation of the pressure roll 140.

In this configuration, the fan 180 blows air to the portion of the pressure roll 140 on the lower side with respect to the center of the rotation of the pressure roll 140. Furthermore, since the inclined portion 188b of the top plate 188 of the guide portion 184 is inclined with respect to the horizontal direction, the fan 180 blows air to the pressure roll 140 such that the direction in which the air is blown is a downward direction with respect to the horizontal direction.

In addition, when the pressure roll 140 rotates counterclockwise in FIG. 9, the fan 180 blows air to the pressure roll 140 such that the air flows in a rotation direction E of the pressure roll 140.

### [Preventing Member 190]

As illustrated in FIG. 9, the preventing member 190 is disposed in the rotation direction E of the pressure roll 140 on the downstream side of the facing position N where the pressure roll 140 and the heating roll 130 face each other and on the upstream side of the portion of the pressure roll 140 to which air is blown by the fan 180. The preventing member 190 faces the pressure roll 140 in a radial direction of the pressure roll 140 and extends in the depth direction of the apparatus.

The preventing member 190 includes a suppressing plate 192 for suppressing movement of air blown to the pressure roll 140 by the fan 180 along the outer peripheral surface of the pressure roll and a flow of air to the sheet member P side, and a curved plate 194 having a facing curved surface 194a facing the rotating storage portion 140a. The suppressing plate 192 is an example of a suppressing member, the curved plate 194 is an example of a formation member, and the facing curved surface 194a is an example of a facing portion.

The suppressing plate 192 has a rectangular shape having a thickness in the vertical direction and extending in the depth direction of the apparatus as viewed from above. The curved plate 194 is attached to an end portion of the suppressing plate 192 on the one side in the width direction of the apparatus.

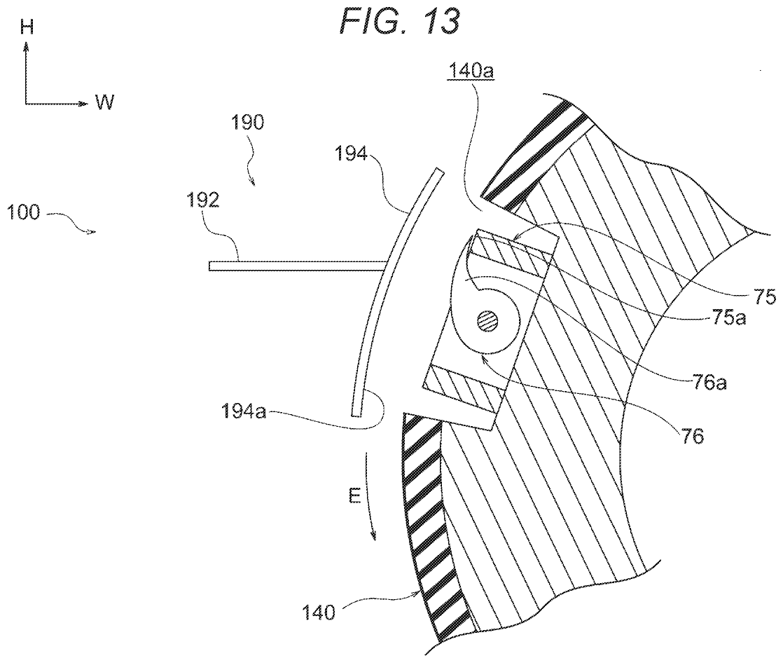

The curved plate 194 extends in the depth direction of the apparatus and has an arc-shaped cross section. Further, the facing curved surface 194a is formed so as to cover the entire storage portion 140a when the curved plate 194 is viewed from an outer side in the radial direction in a state where the facing curved surface 194a faces the storage portion 140a in the radial direction of the pressure roll 140 (refer to FIG. 13).

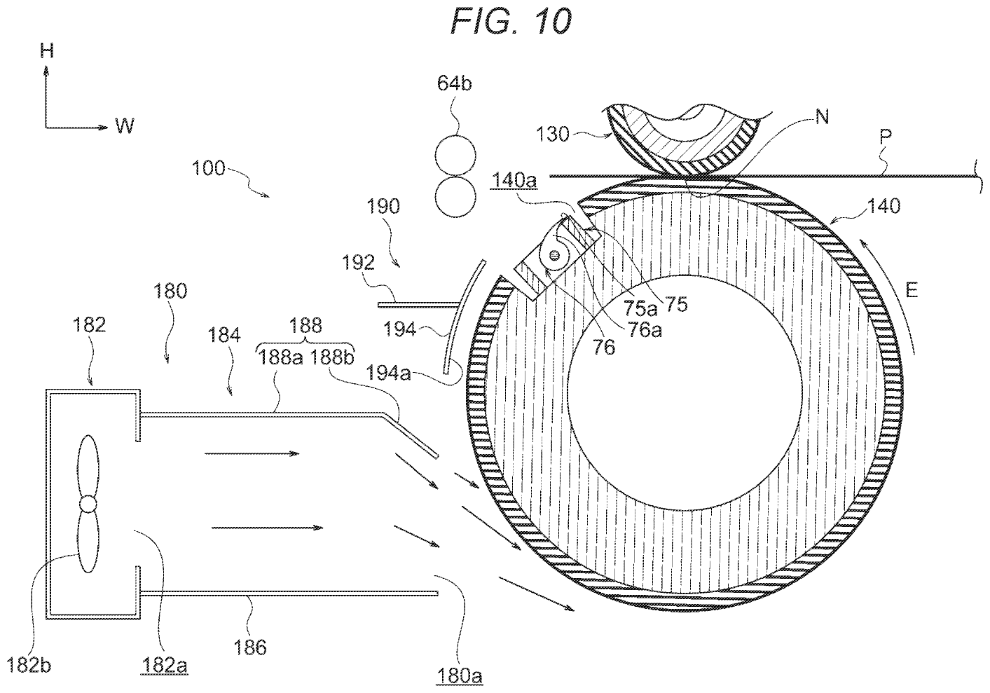

In this configuration, when the sheet member P passes through the facing position N where the pressure roll 140 and the heating roll 130 face each other, as illustrated in FIG. 9, the grippers 76 gripping the leading end of the sheet member P are stored in the storage portion 140a. Then, as illustrated in FIG. 10, the grippers 76 rotate in a state of being stored in the storage portion 140a, and releases the gripping of the leading end of the sheet member P when the leading end of the sheet member P passes through the facing position N where the pressure roll 140 and the heating roll 130 face each other.

Here, when the grippers 76 release the leading end of the sheet member P and air is blown to the sheet member P, it is conceivable that the traveling posture of the sheet member P changes and a conveyance failure occurs. However, the suppressing plate 192 of the preventing member 190 suppresses a flow of air blown to the pressure roll 140 by the fan 180 along the outer peripheral surface of the pressure roll 140 toward the sheet member P being conveyed.

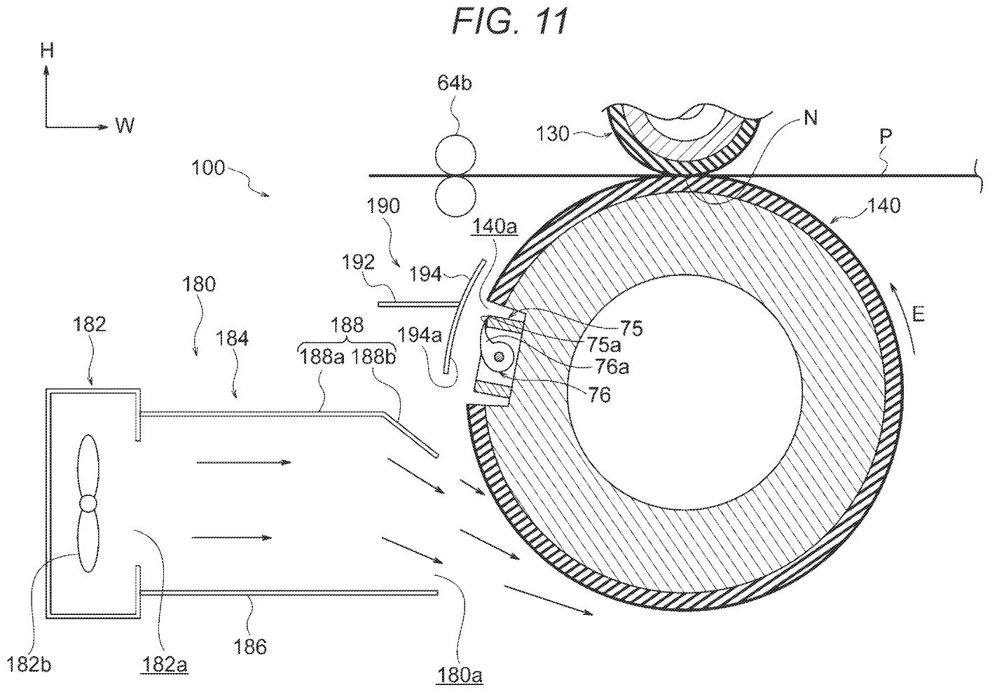

Furthermore, as illustrated in FIG. 11, the grippers 76 rotate in a state of being stored in the storage portion 140a, and the storage portion 140a faces the facing curved surface 194a of the curved plate 194. Further, the leading end of the sheet member P is sandwiched by the conveyance rolls 64a.

In this case, it is conceivable that the air blown to the pressure roll 40 flows to the sheet member P side through the storage portion 140a, the traveling posture of the sheet member P changes, and a conveyance failure occurs. However, the curved plate 194 suppresses a flow of the air to the sheet member P side through the storage portion 140a. To be specific, the curved plate 194 suppresses air freely flowing into and out of the storage portion 140a, thereby suppressing air from flowing to the sheet member P side through the storage portion 140a.

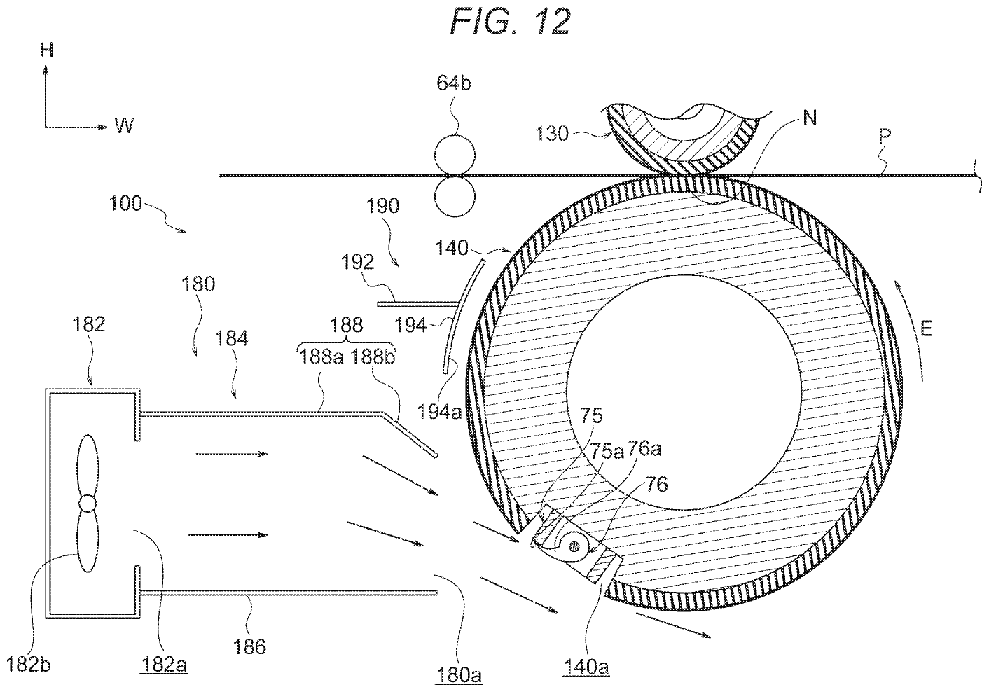

Further, as illustrated in FIG. 12, the grippers 76 rotate in a state of being stored in the storage portion 140a, and the storage portion 140a passes through the blowing port 180a of the fan 180.

### (Effects)

Next, effects of the fan 180 and the preventing member 190 provided in the fixing device 100 will be described with reference to an analysis result obtained by analyzing a flow of air generated by the fan 180. First, a configuration and an analysis result of a fixing device 300 according to a comparative embodiment will be described, and next, an analysis result of the fan 180 and the preventing member 190 provided in the fixing device 100 according to the exemplary embodiment will be described.

### [Fixing Device 300 According to Comparative Embodiment]

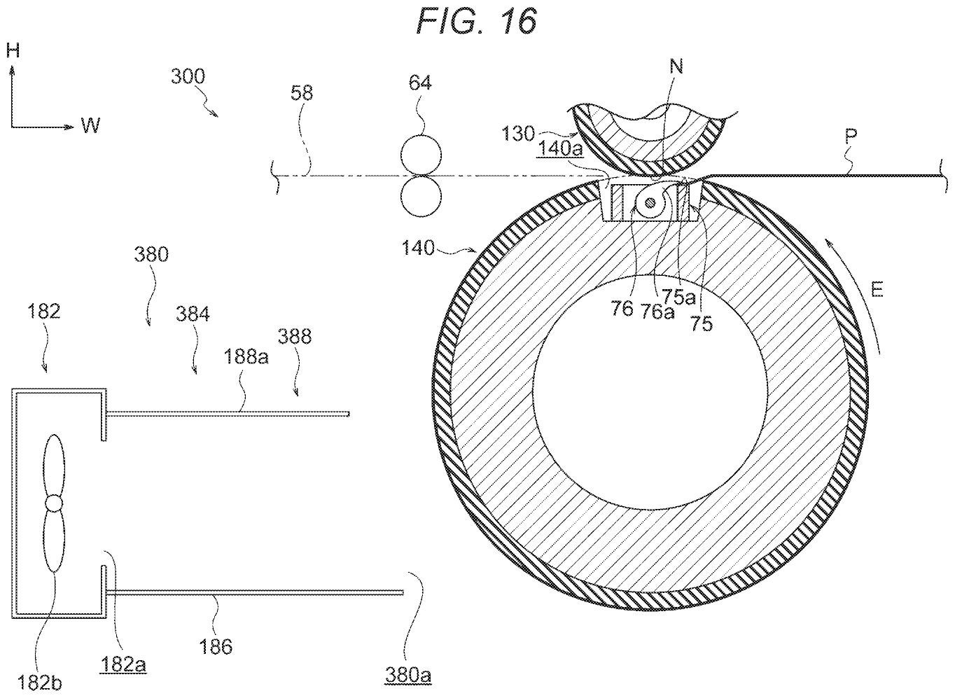

Regarding the configuration of the fixing device 300 according to the comparative embodiment, portions different from the configuration of the fixing device 100 according to the present exemplary embodiment will be mainly described. As illustrated in FIG. 16, the fixing device 300 includes a fan 380 and does not include a preventing member. The fan 380 extends in a depth direction of an apparatus and includes a fan main body 182 and a guide portion 384. The guide portion 384 has a tubular shape, and includes a top plate 388 having a horizontal portion 188a, a bottom plate 186, and a pair of side plates (not illustrated). As described above, the guide portion 384 is not provided with an inclined portion. The top plate 388, the bottom plate 186, and the pair of side plates form a blowing port 380a of the fan 380.

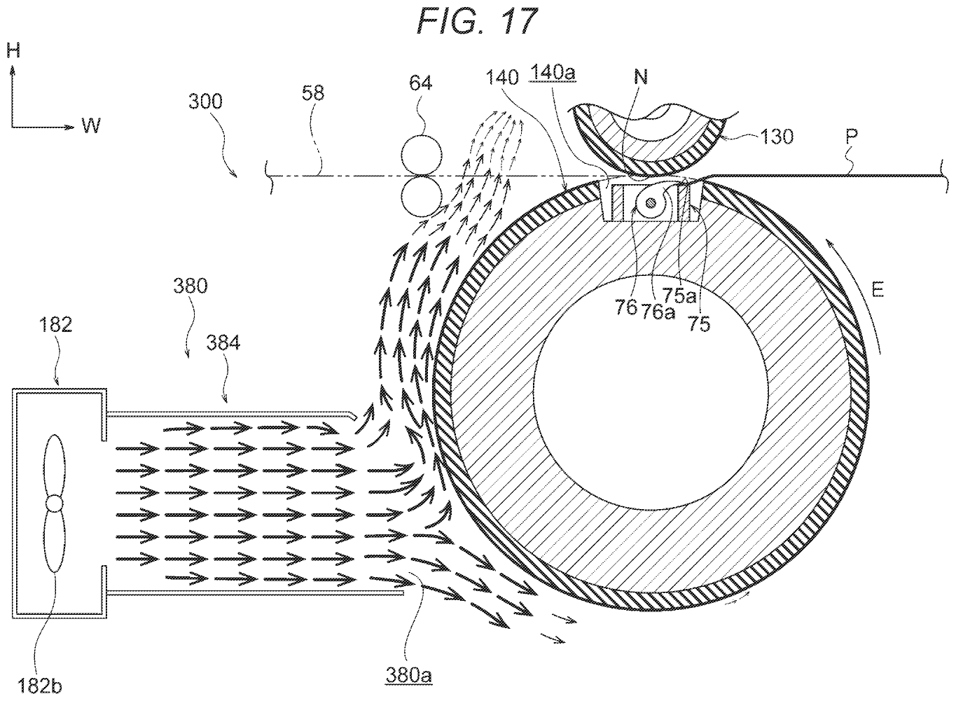

An analysis result of the fixing device 300 according to the comparative embodiment is illustrated in FIG. 17. The directions of arrows illustrated in FIG. 17 represent directions in which air flows. The thickness of each of the arrows indicates a flow velocity. Specifically, as the thickness of the arrow increases, the flow velocity increases as compared with a case where the thickness of the arrow is small. As illustrated in the analysis result in FIG. 17, since an inclined portion (see FIG. 8) is not provided, air blown out from the blowing port 380a of the fan 380 flows horizontally as it is and is blown to a pressure roll 140.

The air blown to the pressure roll 140 flows along the outer peripheral surface of the rotating pressure roll 140. Specifically, the air blown to the pressure roll 140 flows to the downstream side in the rotation direction of the pressure roll 140 and the upstream side in the rotation direction of the pressure roll 140.

The air that has flowed to the upstream side in the rotation direction of the pressure roll 140 flows upward and reaches a conveyance path 58 for a sheet member P.

### [Fixing Device 100 According to Present Exemplary Embodiment]

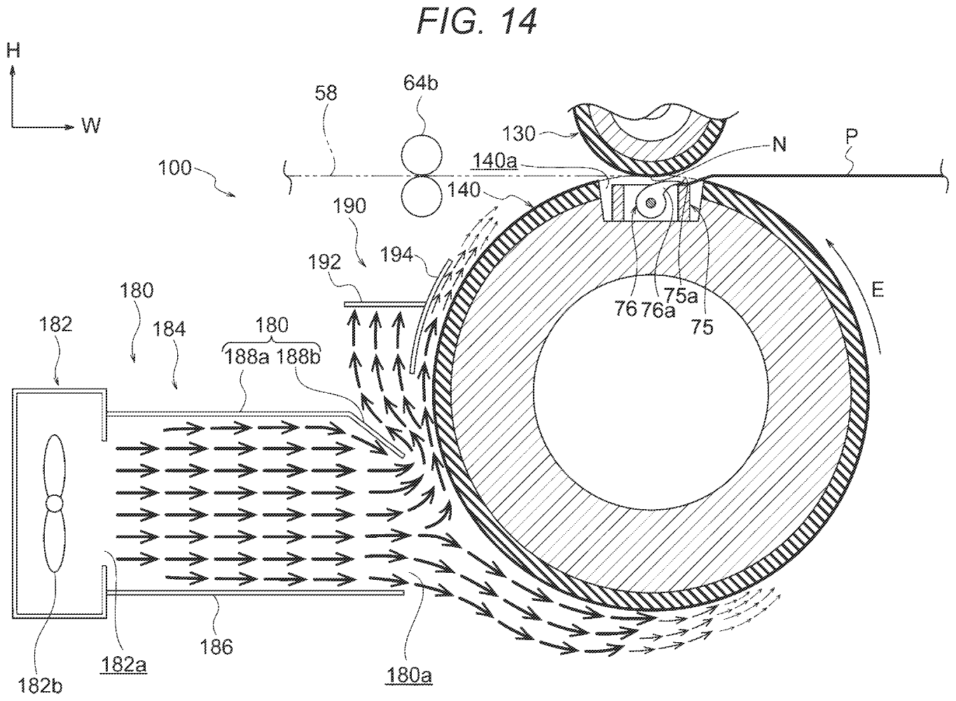

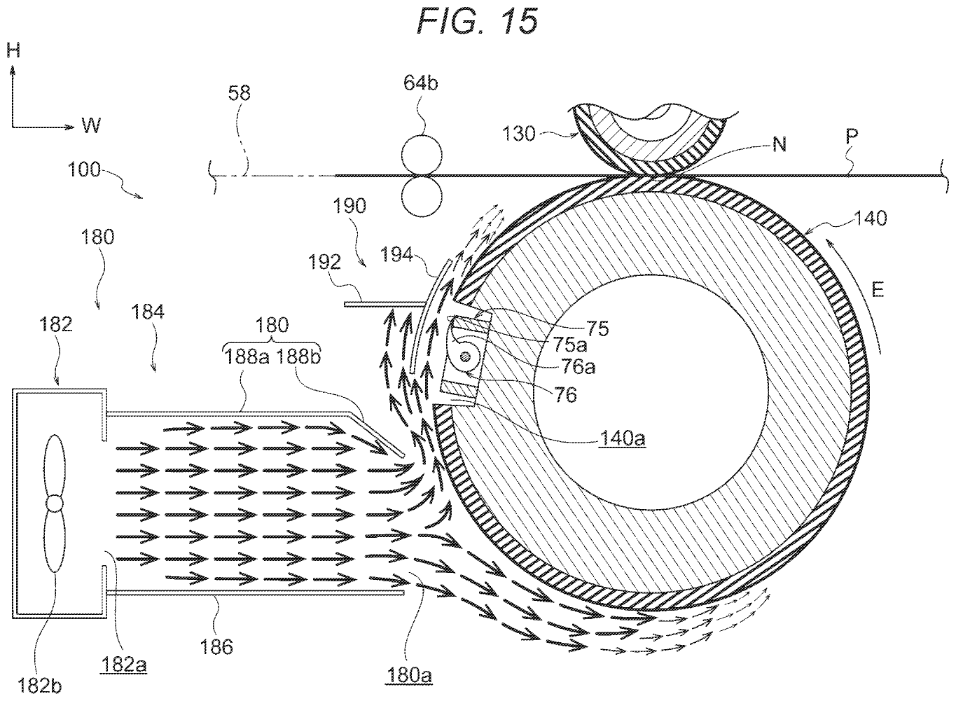

Analysis results of the fixing device 100 according to the present exemplary embodiment are illustrated in FIGS. 14 and 15. As illustrated in the analysis result in FIG. 14, in a state where the grippers 76 are stored in the storage portion 140a so as to face the heating roll 130, air blown out from the outlet port 180a of the fan 180 flows in a downward direction with respect to the horizontal direction and is blown to the pressure roll 140.

The air blown to the pressure roll 140 flows along the outer peripheral surface of the rotating pressure roll 140. Specifically, the air blown to the pressure roll 140 flows to the downstream side in the rotation direction of the pressure roll 140 and the upstream side in the rotation direction of the pressure roll 140.

Most of the air that has flowed to the upstream side in the rotation direction of the pressure roll 140 hits the suppressing plate 192 of the preventing member 190 and a flow of the air to the conveyance path 58 side is suppressed. Another part of the air that has flowed to the upstream side in the rotation direction of the pressure roll 140 flows between the curved plate 194 of the preventing member 190 and the outer peripheral surface of the pressure roll 140 and is directed toward the conveyance path 58 side. However, due to flow path resistance generated by the curved plate 194 and the pressure roll 140, the air flowing toward the conveyance path 58 does not reach the conveyance path 58.

As illustrated in the analysis result in FIG. 15, in a state where the pressure roll 140 rotates and the storage portion 140a in which the grippers 76 are stored faces the curved plate 194 of the preventing member 190, the curved plate 194 suppresses the air flowing toward the sheet member P side through the storage portion 140a. To be specific, the curved plate 194 suppresses air freely flowing into and out of the storage portion 140a, thereby suppressing the air flowing to the sheet member P side through the storage portion 140a. In this manner, the curved plate 194 suppresses the air flowing toward the sheet member P through the storage portion 140a.

### SUMMARY

As described above, in the fixing device 100, the fan 180 cools the pressure roll 140 by blowing air in a direction different from the direction toward the facing position N where the pressure roll 140 and the heating roll 130 are disposed to face each other. In other words, the fan 180 cools the pressure roll by blowing air in a direction different from the direction in which the sheet member P released from the gripping by the grippers 76 faces. Thus, as compared with a case where air blown to the pressure roll for cooling the pressure roll directly hits the sheet member P released from being gripped by the grippers 76, a conveyance failure that occurs in the sheet member P being conveyed is suppressed.

In the fixing device 100, the pressure roll 140 faces the heating roll 130 from a lower side of the heating roll 130, and the fan 180 blows air to the portion of the pressure roll 140 on the lower side with respect to the center of the rotation of the pressure roll 140. Thus, as compared with a case where the fan blows air to a portion of the pressure roll located on the upper side with respect to the center of the rotation of the pressure roll, a conveyance failure that occurs in the sheet member P being conveyed is suppressed.

In the fixing device 100, the fan 180 blows air to the pressure roll 140 such that the air flows in the rotation direction E of the pressure roll 140. Thus, as compared with a case where the fan blows air to the pressure roll such that the air is returned by the rotation of the pressure roll, the air flowing toward the sheet member P is suppressed, whereby a conveyance failure that occurs in the sheet member P being conveyed is suppressed.

Furthermore, in the fixing device 100, the fan 180 blows air toward the pressure roll 140 in a downward direction with respect to the horizontal direction. Thus, the flow of the air toward the sheet member P is suppressed, whereby a conveyance failure that occurs in the sheet member P being conveyed is suppressed, as compared with a case where the fan blows air toward the pressure roll in an upward direction with respect to the horizontal direction.

Further, the fixing device 100 is provided with the suppressing plate 192 for suppressing the air blown to the pressure roll 140 by the fan 180 from flowing toward the sheet member P conveyed along the outer peripheral surface of the pressure roll 140. Thus, as compared with a case where air freely flows along the outer peripheral surface of the pressure roll to a portion of the sheet member P that has passed through the facing position, a conveyance failure that occurs in the sheet member P being conveyed is suppressed. In other words, a conveyance failure that occurs in the sheet member P being conveyed is more suppressed than in a case where a flow path through which air flows toward a portion of the sheet member P that has passed through the facing position along the outer peripheral surface of the pressure roll is secured.

In addition, the fixing device 100 is provided with the curved plate 194 in which the facing curved surface 140a that faces the rotating storage portion 194a is formed. Thus, the air flowing toward the sheet member P through the storage portion 140a is suppressed as compared with a case where the air blown to the pressure roll freely flows into and flows out of the storage portion, whereby a conveyance failure that occurs in the sheet member P being conveyed is suppressed. In other words, compared with a case where a member that suppresses a flow of air blown to the pressure roll from into the storage portion is not provided, a flow of air to the sheet member P side through the storage portion 140a is suppressed, and thus a conveyance failure that occurs in the sheet member P being conveyed is suppressed.

Furthermore, in the fixing device 100, the facing curved surface 194a entirely covers the storage portion 140a as viewed from the outer side in the radial direction of the pressure roll 140 in a state where the facing curved surface 194a faces the storage portion 140a in the radial direction of the pressure roll 140. Accordingly, as compared with a case where a part of the storage portion can be visually recognized from the periphery of the curved plate as viewed from the outer side in the radial direction of the pressure roll in a state where the facing curved surface faces the storage portion, a flow of air to the sheet member P side through the storage portion 140a is suppressed, and thus a conveyance failure that occurs in the sheet member P being conveyed is suppressed.

Furthermore, as compared with a case where a fixing device is provided in which air is blown so as to directly hit a sheet member P released from being gripped by a gripper 76 in order to cool a pressure roll, the traveling posture of the sheet member P is stabilized, and thus a sheet jam of the sheet member P is suppressed in the image forming apparatus 10.

Although a specific exemplary embodiment of the present disclosure has been described in detail, the present disclosure is not limited to the exemplary embodiment, and it is apparent to those skilled in the art that various other exemplary embodiments can be adopted within the scope of the present disclosure. For example, in the above-described exemplary embodiment, the fan 180 blows air to the pressure roll 140 such that the air flows in the rotation direction E of the pressure roll 140, but the fan 180 may blow air such that the air is pushed back by the rotating pressure roll. However, in this case, the effect achieved by blowing air to the pressure roll 140 such that the air flows in the rotation direction E of the pressure roll 140 is not achieved.

Furthermore, although the fan 180 blows air toward the pressure roll 140 in a downward direction with respect to the horizontal direction in the exemplary embodiment described above, the fan 180 may blow air in the horizontal direction or may blow air in an upward direction with respect to the horizontal direction. However, in this case, the effect achieved by blowing air in a downward direction with respect to the horizontal direction is not achieved.

Furthermore, although air is blown to the pressure roll 140 by using the fan 180 in the exemplary embodiment described above, a blower or the like may blow air to the pressure roll 140.

In the above-described exemplary embodiment, the pressure roll 140 faces the heating roll 130 from the lower side of the heating roll 130. However, the pressure roll 140 may face the heating roll 130 from a side different from the lower side. In this case, the effect achieved by the pressure roll 140 facing the heating roll 130 from the lower side of the heating roll 130 is not achieved.

In the above-described exemplary embodiment, the suppressing plate 192 that suppresses a flow of air blown to the pressure roll by the fan 180 toward the sheet member P side along the outer peripheral surface of the pressure roll 140 is provided. However, the suppressing plate 192 may not be provided. However, in this case, the effect achieved by providing the suppressing plate 192 is not achieved.

Furthermore, although the curved plate 194 in which the facing curved surface 140a facing the rotating storage portion 194a is formed is provided in the exemplary embodiment described above, the curved plate 194 may not be provided. However, in this case, the effect achieved by providing the curved plate 194 is not achieved.

Although not particularly described in the above-described exemplary embodiment, in order to form images on both surfaces of the sheet member P, a reversing path for reversing the front and back of the sheet member P may be provided downstream of the facing position N, an image may be formed on the back surface of the sheet member P, and the sheet member P with the back surface on which the image is formed may pass through the facing position N again.

Furthermore, although the conveyance rolls 64b that sandwich and convey the sheet member P are provided downstream of the facing position N in the conveyance direction of the sheet member P in the exemplary embodiment described above, a belt conveyance member that attracts and conveys the sheet member P may be provided on the endless belt.
(((1))) A fixing device comprising:
a conveyance section that conveys a recording medium;
a heating roll that rotates and heats the recording medium being conveyed by the conveyance section;
a pressure roll that is disposed to face the heating roll and rotates, around which at least a portion of the recording medium being conveyed is wound, and that pressurizes the wound portion of the recording medium toward the heating roll;
a gripping section that is disposed in the conveyance section, grips a leading end of the recording medium being conveyed, and releases the gripping of the leading end of the recording medium when the recording medium passes through a facing position where the pressure roll and the heating roll face each other; and
a blowing section that blows air in a direction different from a direction toward the recording medium released from being gripped by the gripping section to cool the pressure roll. (((2))) The fixing device according to (((1))), wherein
the pressure roll faces the heating roll from a lower side of the heating roll, and the blowing section blows air to a portion of the pressure roll that is on a lower side with respect to a center of rotation of the pressure roll.
((((3))) The fixing device according to ((((2))), wherein
the blowing section blows air to the pressure roll such that the air flows in a rotation direction of the pressure roll.
(((4))) The fixing device according to ((((3))), wherein
the blowing section blows air in a downward direction with respect to a horizontal direction.
(((5))) The fixing device according to any one of (((2))) to (((4))), comprising:
a suppressing member that is disposed downstream of the facing position and upstream of a portion of the pressure roll to which air is blown by the blowing section in a rotation direction of the pressure roll, and that suppresses a flow of the air blown to the pressure roll by the blowing section along an outer peripheral surface of the pressure roll to a portion of the recording medium that has passed through the facing position.
((((6))) The fixing device according to any one of ((((2))) to ((((5))), wherein
a recessed storage portion in which the gripping section is stored is formed in an outer peripheral surface of the pressure roll, and
the fixing device comprises a formation member that is disposed downstream of the facing position and upstream of a portion of the pressure roll to which air is blown by the blowing section in a rotation direction of the pressure roll, and in which a facing portion facing the storage portion that rotates is formed.
(((7))) The fixing device according to ((((6))), wherein
when the formation member is viewed from an outer side in a radial direction of the pressure roll in a state where the facing portion faces the storage portion, the facing portion entirely covers the storage portion.
(((8))) An image forming apparatus comprising:
a transfer section that transfers a toner image onto a recording medium; and
the fixing device according to any one of (((1))) to (((7)) that fixes, to the recording medium, the toner image transferred onto the recording medium.

What is claimed is:

1. A fixing device comprising:
a conveyance section that conveys a recording medium;
a heating roll that rotates and heats the recording medium being conveyed by the conveyance section;
a pressure roll that is disposed to face the heating roll and rotates, around which at least a portion of the recording medium being conveyed is wound, and that pressurizes the wound portion of the recording medium toward the heating roll;
a gripping section that is disposed in the conveyance section, grips a leading end of the recording medium being conveyed, and releases the gripping of the leading end of the recording medium when the recording medium passes through a facing position where the pressure roll and the heating roll face each other; and
a blowing section that blows air in a direction different from a direction toward the recording medium released from being gripped by the gripping section to cool the pressure roll.

2. The fixing device according to claim 1, wherein
the pressure roll faces the heating roll from a lower side of the heating roll, and the blowing section blows air to a portion of the pressure roll that is on a lower side with respect to a center of rotation of the pressure roll.

3. The fixing device according to claim 2, wherein
the blowing section blows air to the pressure roll such that the air flows in a rotation direction of the pressure roll.

4. The fixing device according to claim 3, wherein
the blowing section blows air in a downward direction with respect to a horizontal direction.

5. The fixing device according to claim 2, comprising:
a suppressing member that is disposed downstream of the facing position and upstream side of a portion of the pressure roll to which air is blown by the blowing section in a rotation direction of the pressure roll, and that suppresses a flow of the air blown to the pressure roll by the blowing section along an outer peripheral surface of the pressure roll to a portion of the recording medium that has passed through the facing position.

6. The fixing device according to claim 2, wherein
a recessed storage portion in which the gripping section is stored is formed in an outer peripheral surface of the pressure roll, and
the fixing device comprises a formation member that is disposed downstream of the facing position and upstream of a portion of the pressure roll to which air is blown by the blowing section in a rotation direction of the pressure roll, and in which a facing portion facing the storage portion that rotates is formed.

7. The fixing device according to claim 6, wherein
when the formation member is viewed from an outer side in a radial direction of the pressure roll in a state where the facing portion faces the storage portion, the facing portion entirely covers the storage portion.

8. An image forming apparatus comprising:
a transfer section that transfers a toner image onto a recording medium; and
the fixing device according to claim 1 that fixes, to the recording medium, the toner image transferred onto the recording medium.

9. An image forming apparatus comprising:
a transfer section that transfers a toner image onto a recording medium; and
the fixing device according to claim 2 that fixes, to the recording medium, the toner image transferred onto the recording medium.

10. An image forming apparatus comprising:
a transfer section that transfers a toner image onto a recording medium; and
the fixing device according to claim 3 that fixes, to the recording medium, the toner image transferred onto the recording medium.

11. An image forming apparatus comprising:
a transfer section that transfers a toner image onto a recording medium; and
the fixing device according to claim 4 that fixes, to the recording medium, the toner image transferred onto the recording medium.

12. An image forming apparatus comprising:
a transfer section that transfers a toner image onto a recording medium; and
the fixing device according to claim 5 that fixes, to the recording medium, the toner image transferred onto the recording medium.

13. An image forming apparatus comprising:
a transfer section that transfers a toner image onto a recording medium; and
the fixing device according to claim 6 that fixes, to the recording medium, the toner image transferred onto the recording medium.

14. An image forming apparatus comprising:
a transfer section that transfers a toner image onto a recording medium; and
the fixing device according to claim 7 that fixes, to the recording medium, the toner image transferred onto the recording medium.
